(19) United States
(12) Patent Application Publication
(10) Pub. No.: US 2010/0145675 A1
(43) Pub. Date: Jun. 10, 2010

(54) USER INTERFACE HAVING CUSTOMIZABLE TEXT STRINGS

(75) Inventors: Owen W. Lloyd, Redmond, WA (US); John A. Yovin, Woodinville, WA (US); Kenneth Q. Sabotta, Seattle, WA (US); Teresa M. Peters, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/328,091

(22) Filed: Dec. 4, 2008

(51) Int. Cl. G06F 17/20

(52) U.S. Cl. 704/8

(57) ABSTRACT

A user interface having customizable text strings is described. In an implementation, a mobile communication device comprises one or more modules to provide an option to specify a target demographic for the mobile communication device. The option is configured such that a language, intended market, and at least one other characteristic of the target demographic may be specified. One or more text strings may then be obtained based on the target demographic that was specified to be output in a user interface on the mobile communication device.

### BACKGROUND

The use of mobile communication devices (e.g., wireless phones) has continued to expand across a wide variety of users. For instance, when traditional cellular phones were first introduced business users formed the vast majority of purchasers of the phones due to cost of the phones themselves as well as the cost of using the pones.

However, as prices decreased, use of the phones and other mobile communication devices expanded to a wide variety of different users. For example, non-business uses became increasingly more prevalent, such as use by teenagers. However, these different users may interact with the phones for different purposes and in different ways. Therefore, a phone (or other mobile communication device) that is considered appropriate for a particular set of users may be less appropriate for another set of users.

### SUMMARY

A user interface having customizable text strings is described. In an implementation, a mobile communication device comprises one or more modules to provide an option to specify a target demographic for the mobile communication device. The option is configured such that a language, intended market, and at least one other characteristic of the target demographic may be specified. One or more text strings may then be obtained based on the target demographic that was specified to be output in a user interface on the mobile communication device.

In an implementation, a plurality of themes is made accessible at a site over a network, each to be applied to a user interface of a mobile communication device. One or more of the themes are targetable to a particular demographic through customizable text strings. Revenue is collected that is based at least in part on access to at least one of the themes.

In an implementation, one or more computer-readable media comprise instructions that are executable by a device to output an option to customize text strings that are to be output in a user interface by the device in response to an occurrence of a respective one of a plurality of events that relate to receipt of a communication at the device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to perform techniques to customize strings to be output in a user interface.

FIG. 2 is an illustration of a system in an example implementation showing output of a user interface on a mobile communications device of FIG. 1 in greater detail.

FIG. 3 is another illustration of a system in an example implementation showing output of a user interface on a mobile communications device of FIG. 1 in greater detail.

FIG. 4 is a flow diagram depicting a procedure in an example implementation in which a localization option is output to target a user interface to a particular demographic.

FIG. is a flow diagram depicting a procedure in an example implementation in which themes having text strings that are targetable to a particular demographic are made available via a site.

FIG. 6 is a flow diagram depicting a procedure in an example implementation in which text strings are customized by a user for output in a user interface.

FIG. 7 is an illustration of an example device that may provide mobile communication device functionality.

### DETAILED DESCRIPTION

Overview

Initially, use of traditional mobile communication devices (such as wireless phones) was oftentimes limited to business use due to cost considerations. However, as costs decreased over time use of mobile communication devices has expanded to include a wide range of users in a wide range of demographics. Therefore, optimizing a mobile communication device for a set of users in one demographic may make it unsuitable for a set of users in another demographic, thereby reducing marketability of the mobile communication device.

Techniques to customize text strings for output in a user interface are described. In an implementation, different themes may be selected to target text strings to a particular demographic. These text strings may then be output in response to an occurrence of an event at the mobile communication device. For instance, a theme may be selected to target a demographic of English-speaking users in the United States that are teenagers by inputting “en-us-tn”. Text strings may then be obtained for output, the text strings being associated with that theme. For example, the theme that is targeted to this demographic may be used to output “Txt from Sara” when a text is received. In another instance, a business user may select a business-related theme (e.g., “en-us-bu”), which causes an output of “You have received a text message from Sara” when a text is received. In this way, the actual text included in the text string may be targeted to different demographics, thereby increasing the likelihood that users in these different demographics will find the mobile communication device desirable. Although output of text in relation to notifications has been described, a variety of different text may be customized, e.g., to label an application in different ways such as a “browser” vs. “web browser.”

In the following discussion, a variety of example implementations of a mobile communication device are shown. Additionally, a variety of different functionality that may be employed by the mobile communication devices is described for each example, which may be implemented in that example as well as in other described examples. Accordingly, example implementations are illustrated of a few of a variety of contemplated implementations. Further, although a mobile communication device having one or more modules that are configured to provide telephonic functionality are described, a variety of other mobile communication devices are also contemplated, such as dedicated messaging devices, music players, portable game devices, and so on.

Example Environment

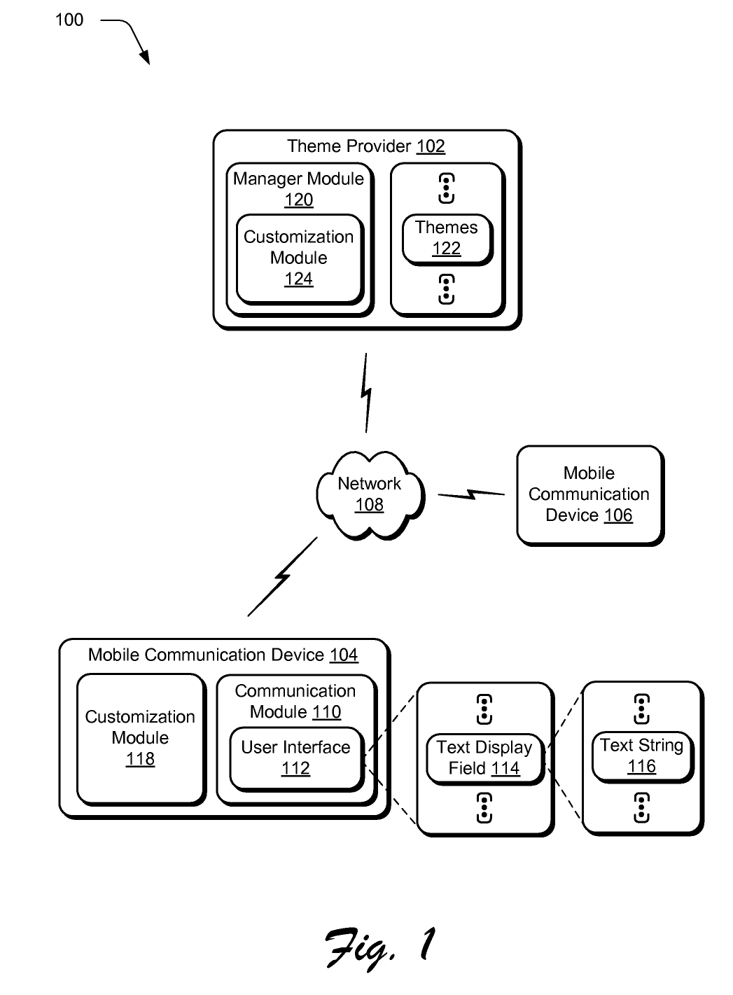

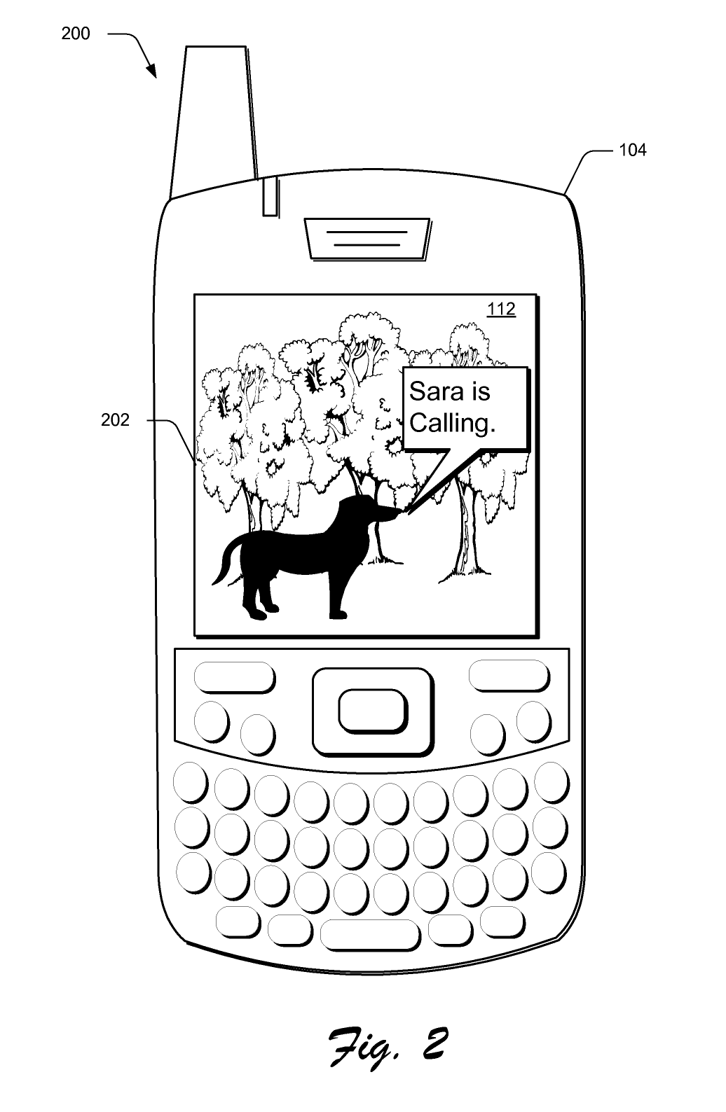

FIG. 1 is an illustration of an environment 100 in an example implementation that is operable to employ techniques to customize a user interface with text strings. The illustrated environment 100 includes a theme provider 102, a mobile communication device 104, and another mobile communication device 106, each of which are communicatively coupled, one to another, over a network 108. The mobile communication devices 104, 106 may be configured in a variety of ways, such as wireless phones, music players, portable game devices, and so on.

Although the network 108 is illustrated as the Internet, the network 108 may assume a wide variety of configurations. For example, the network 108 may include a wide area network (WAN), a local area network (LAN), a wireless network, a public telephone network, an intranet, and so on. Further, although a single network 108 is shown, the network 108 may be configured to include multiple networks. For instance, the mobile communication devices 104, 106 may be configured to communicate, one to another, via a wireless telephone network. Additionally, the theme provider 102 may be accessible to the mobile communication devices 104, 106 via the Internet. A wide variety of other instances are also contemplated.

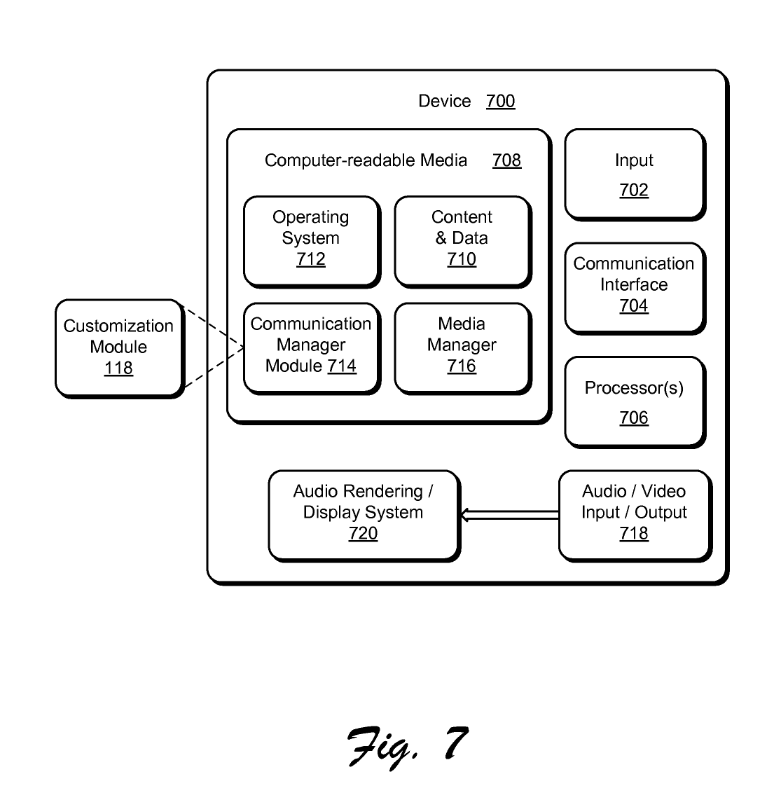

The mobile communication device 104 is illustrated as including a communication module 110 that is representative of functionality of the mobile communication device 104 to communicate via the network 106. For example, the communication module 110 may include telephone functionality that enables the mobile communication device 104 to make and receive telephone calls via the network 108. A variety of other communication techniques may also be supported by the communication module 110, such as text messaging, instant messaging, multimedia messaging, email, web browsing, and so on, further discussion of which may be found in relation to FIG. 7.

The communication module 110 is illustrated in the environment 100 of FIG. 1 as including a user interface 112 via which a user may interact with the communication functionality and other functionality (e.g., to run applications) provided by communication module 110. For example, the user interface 112 may be output on a display device via which a user may interact, such as via a touchscreen, cursor control device, and so on.

The user interface 112 includes one or more text display fields 114 that are to be used to output one or more text strings 116. The text strings 116 may be output in the text display fields 114 in a variety of ways, such as to provide notifications, instructions, and so on. For example, an event may occur at the mobile communication device 104 that causes a notification to be output, such as receipt of a telephone call, a low battery condition, and so on. Accordingly, a text display field 114 may be used to output a text string 116 that relates to that event, such as “Battery is below 5%”.

The mobile communication device 104 is also illustrated as including a customization module 118 that is representative of functionality to customize text strings 116 for output in the text display field 114. For example, the customization module 118 may select particular text strings 116 to be output in a text display field 114 based on a demographic of a likely user of the mobile communication device 104, e.g., to use “Low Battery” instead of “Battery is below 5%” as in the previous example. Thus, the actual text itself may be customized for a target demographic along with how the text appears (e.g., font and color), background of the user interface 112, and so on to provide different themes for the mobile communication device 104.

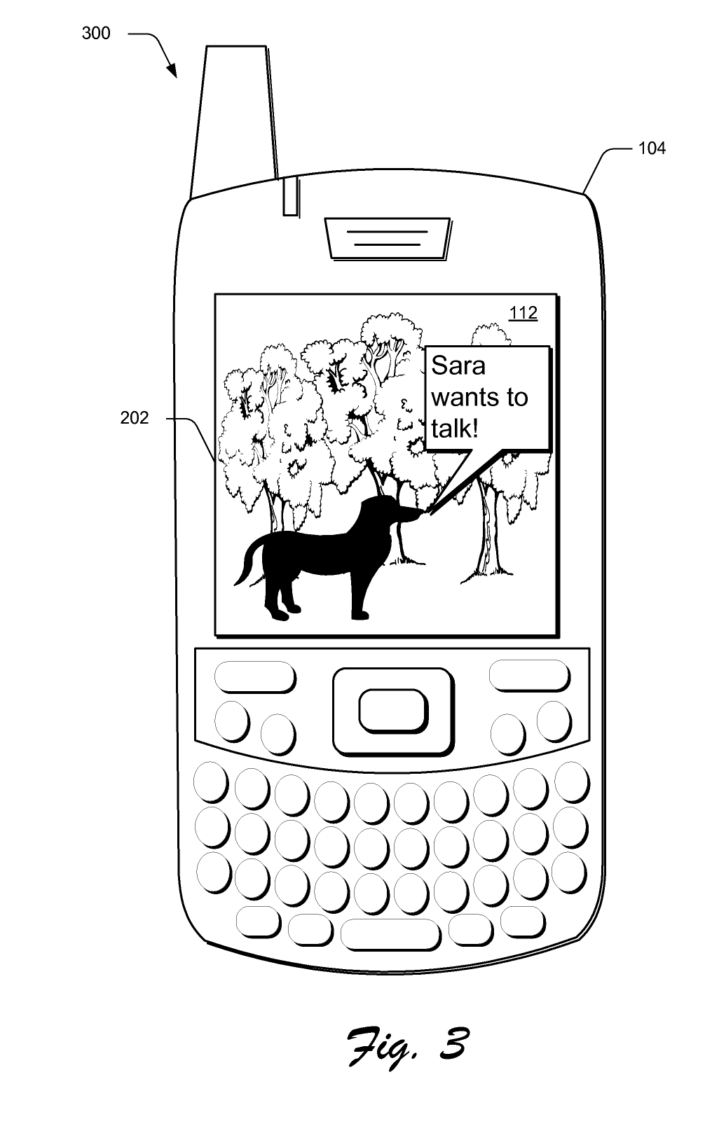

For example, the customization module 110 may provide an option to enter information that describes a target demographic, such as English-U.S.-Business (e.g., en-us-bu). Text strings that correspond with that demographic may then be obtained by the customization module 110 for output in the user interface 112. As shown in FIG. 2, for instance, the mobile communication device 104 may output the user interface 112 on a display device 202. The user interface 112 includes a background of a dog and trees and an output of a text string in a talk balloon that states “Sara is Calling”. Thus, a contact may be retrieved by the customization module 110 that corresponds to an incoming phone number, which is then combined with a text string that is targeted to that demographic to form the output text string.

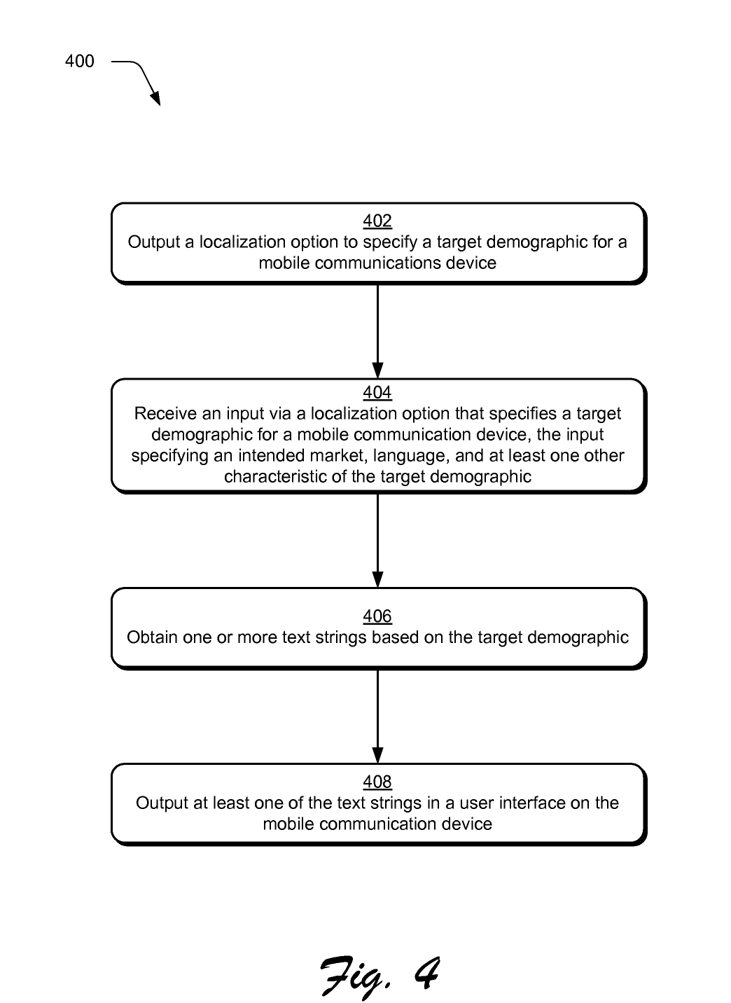

In another instance, the customization module 110 may be targeted toward another demographic, such as an English-speaking teenager in the U.S. (e.g., English-U.S.-Teenager) which may be entered as “en-us-tn”. Accordingly, text strings that correspond with that demographic may then be obtained by the customization module 110 and output in the user interface 112. As shown in FIG. 3, for instance, the user interface 112 includes a text string in a talk balloon that states “Sara wants to talk!” Thus, in this instance the text string that is output is targeted toward a less formal demographic. A variety of other instances are also contemplated, further discussion of which may be found in relation to the example procedure.

Returning back to FIG. 1, customization of the text strings may be accomplished in a variety of ways. For example, the theme provider 102 may include a manager module 120 that is representative of functionality to manage exposure of one or more themes 122 having custom text strings. The mobile communication devices 104, 106 may access the theme provider 102 via the network 108 to obtain the themes 112, which may then be used to control which text strings 116 are output in the text display fields 114. Thus, in this example the theme provider 102 may provide preconfigured themes 122 to be employed by the user interface 112 of the mobile communication device 104.

In another example, the theme provider 102 may also include the functionality of the customization module 118 of the mobile communication device 104, which is illustrated by inclusion of customization module 124 with the manager module 120 of the theme provider 102. The customization module 124 may output a user interface via which a user may enter customized text strings to be output in the text display fields 114 of the user interface 112. For instance, a user may specify a text string “Txt from ______” to be used for incoming text messages. In this way, a user may provide customized text strings as desired to personalize the user's experience with the mobile communication device 104. Similar functionality may also be provided by the customization module 118 that is local to the mobile communication device 104 without departing from the spirit and scope thereof. Further discussion of custom text strings may be found in relation to the following procedures.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, further description of which may be found in relation to FIG. 5. The features of the text string customization techniques described below are platform-independent, meaning that the techniques may be implemented on a variety of commercial computing platforms having a variety of processors.

Example Procedures

The following discussion describes user interface techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and implementations of FIGS. 2 and 3.

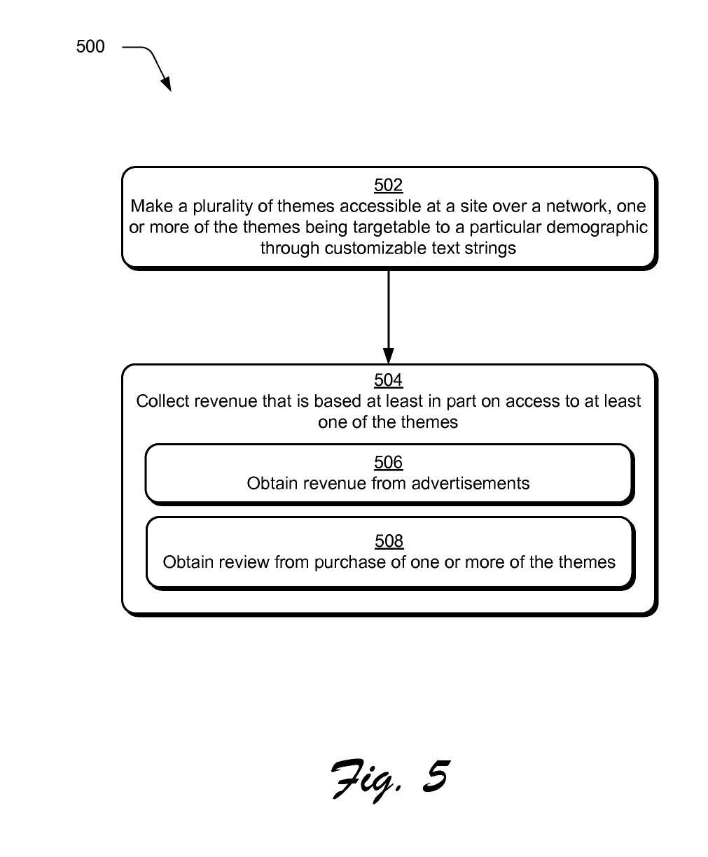

FIG. 4 depicts a procedure 400 in an example implementation in which a localization option is output to target a user interface to a particular demographic. A localization option is output to specify a target demographic for a mobile communication device (block 402). For example, the localization option may be output for customization by a manufacturer, a service provider, a user, and so on.

An input is received via the localization option that specifies a target demographic for the mobile communication device, the input specifying an intended market, a language, and at least one other characteristic of the target demographic (block 404). For example, a user may specify a language and market such as “English—United States,” “English—Canada,” and so on through a language code and a country code such as “en-us”, “en-ca,” respectively. The other characteristic may also be specified using this convention, such as “en-us-bu” for English, United States, business, “en-ca-tn” for English, Canada, teenager, and so on. A variety of other techniques may also be used, such as to specify a particular age range of a target demographic, whether the target demographic is to use the device for business or personal purposes, and so on. These different demographics may be input by a manufacturer, through interaction with the user interface 112 by a user of the mobile communication device 104, and so on.

One or more text strings are obtained based on the target demographic (block 406). For example, the customization module 118 may obtain one or more text strings 116 that correspond to the target demographic. This may be performed in a variety of ways, such as by identifying a type associated with each of the text strings 116, by obtaining a theme that contains a collection of text strings that correspond to the target demographic, and so on.

At least one of the text strings is output in a user interface on the mobile communication device (block 408). For example, the text string 116 may be output as a notification of an occurrence of an event at the mobile communication device 104, which may pertain to hardware and/or software (e.g., applications) of the mobile communication device 104. A variety of other examples are also contemplated, further discussion of which may be found in relation to the following figure.

FIG. 5 depicts a procedure 500 in an example implementation in which themes having text strings that are targetable to a particular demographic are made available via a site. A plurality of themes are made accessible at a site over a network, one or more of the themes being targetable to a particular demographic through customizable text strings (block 502). For example, a website may be exposed by the theme provider 102 of FIG. 1 to provide one or more themes 122 that are accessible via the network 108 by the mobile communication devices 104, 106. Each of the themes 122 may include text strings 116 that are targeted to a respective demographic, such as business users, teenagers, sports fans, and so on. These text strings 116 may then be output in corresponding text display fields 114 of the user interface 112 as previously described in relation to FIGS. 1-3.

Revenue is collected that is based at least in part on access to at least one of the themes (block 504). This revenue may be collected in a variety of different ways. For example, the revenue may be obtained for display of advertisements (block 506) at a website. In another example, revenue may be obtained from purchase of one or more of the themes (block 508) by users that visit the site. For instance, the theme provider 102 may charge a fee for download of the theme 122, may provide a subscription rate for download of themes 122 for a period of time, and so on. A variety of other examples are also contemplated, such as an output of the user interface by the customization module 118 such that a user may enter any desired text string 116 to be output in respective text display fields 114, further discussion of which may be found in relation to the following figure.

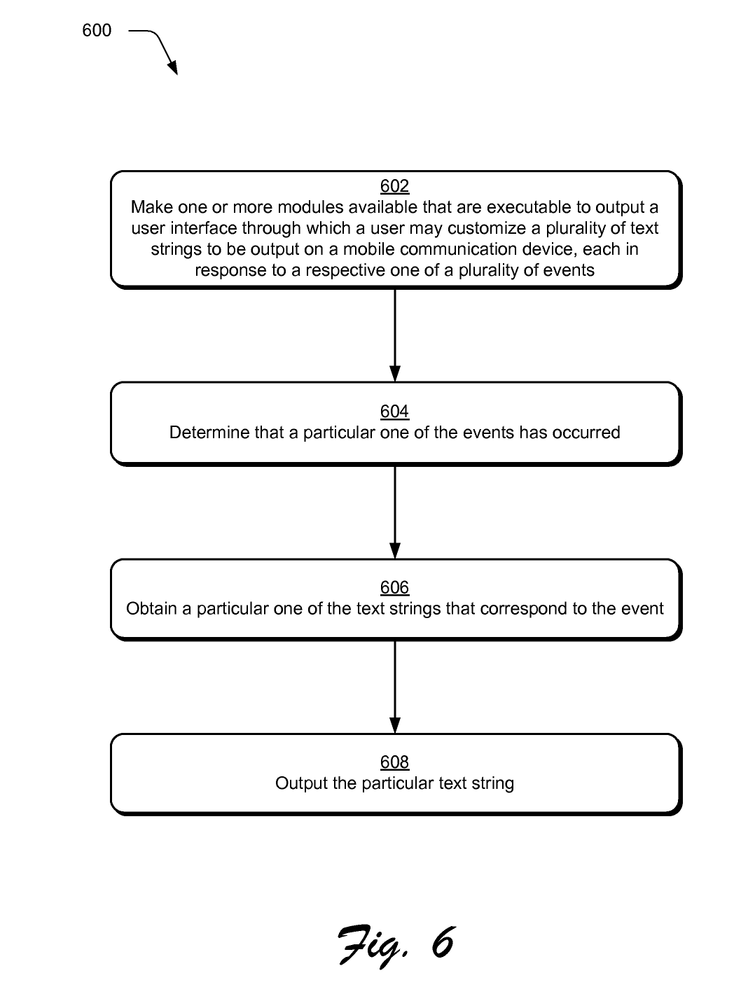

FIG. 6 depicts a procedure 600 in an example implementation in which text strings are customized by a user for output in a user interface. One or more modules are made available that are executable to output a user interface through which a user may customize a plurality of text strings to be output on a mobile communication device, each in response to respective one of a plurality of events (block 602). For example, the theme provider 102 may make the one or more modules available to the mobile communication device 104 via the network 108, such as a website. In another example, the one or more modules may be made available via computer readable media that may be purchased by the user, downloaded by the user, and so on.

A determination is made that a particular one of the events has occurred (block 604). As previously described, a variety of different events may occur at the mobile communication device 104, such as events that relate to hardware (e.g., a low battery event), software (e.g., through execution of one or more applications by the mobile communication device 104), and so on. Monitoring of the events may be performed in a variety of different ways, such as by an operating system of the mobile communication device 104 in which the operating system includes functionality of the customization module 118 previously described.

A particular one of the text strings are obtained that corresponds to the event (block 606). For example, a text string may be obtained that states “your battery is low” when the battery level of the mobile communication device 104 drops below 5%. The particular text string is then output (block 608), such as displayed in the user interface 112 on a display device, output as audio by a speaker, and so on.

Example Device

FIG. 7 illustrates various components of an example device 700 that can be implemented in various embodiments as any type of a mobile device to implement embodiments of devices, features, and systems for mobile communications. For example, device 700 can be implemented as any of the mobile communications devices 102 described with reference to respective FIGS. 1-6. Device 700 can also be implemented to access a network-based service, such as a content service.

Device 700 includes input(s) 702 that may include Internet Protocol (IP) inputs as well as other input devices, such as a keyboard. Device 700 further includes communication interface(s) 704 that can be implemented as any one or more of a wireless interface, any type of network interface, and as any other type of communication interface. A network interface provides a connection between device 700 and a communication network by which other devices can communicate data with device 700. A wireless interface enables device 700 to operate as a mobile device for wireless communications.

Device 700 also includes one or more processors 706 (e.g., any of microprocessors, controllers, and the like) which process various computer-executable instructions to control the operation of device 700 and to communicate with other electronic devices. Device 700 can be implemented with computer-readable media 708, such as one or more memory components, examples of which include random access memory (RAM) and non-volatile memory (e.g., any one or more of a read-only memory (ROM), flash memory, EPROM, EEPROM, etc.).

Computer-readable media 708 provides data storage to store content and data 710, as well as device applications and any other types of information and/or data related to operational aspects of device 700. For example, an operating system 712 can be maintained as a computer application with the computer-readable media 708 and executed on processor(s) 706. Device applications can also include a communication manager module 714 (which may be used to provide telephonic functionality) and a media manager 716.

Device 700 also includes an audio and/or video output 718 that provides audio and/or video data to an audio rendering and/or display system 720. The audio rendering and/or display system 720 can be implemented as integrated component(s) of the example device 700, and can include any components that process, display, and/or otherwise render audio, video, and image data. Device 700 can also be implemented to provide a user tactile feedback, such as vibrate and haptics.

The communication manager module 714 is further illustrated as including the customization module 118 of FIG. 1. As previously described, the customization module 118 is representative of functionality to customize, select and/or output text strings 116 in a text display field 114 of a user interface 112.

Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A mobile communication device comprising one or more modules to:
provide an option to specify a target demographic for the mobile communication device, the option to specify a language, intended market, and at least one other characteristic of the target demographic; and
obtain one or more text strings based on the target demographic to be output in a user interface on the mobile communication device.

2. A mobile communication device as described in claim 1, wherein the language and the intended market are specified using a language code and a country code, respectively.

3. A mobile communication device as described in claim 2, wherein the at least one other characteristic of the target demographic is an age group.

4. A mobile communication device as described in claim 2, wherein the at least one other characteristic of the target demographic is whether the mobile communication device is to be used for personal or business purposes.

5. A mobile communication device as described in claim 1, wherein the option is output by the mobile communication device via a user interface.

6. A mobile communication device as described in claim 1, wherein each of the one or more text strings are output in response to an occurrence of respective one of a plurality of events.

7. A mobile communication device as described in claim 6, wherein at least one of the events is an incoming telephone call.

8. A method as described in claim 6, wherein at least one of the events is receipt of a text message.

9. A mobile communication device as described in claim 6, wherein at least one of the events is receipt of an email.

10. A mobile communication device as described in claim 1, wherein the one or more modules that provide the option and obtain the one or more text strings are part of an operating system.

11. A mobile communication device as described in claim 1, wherein the one or more modules provide the option via a user interface that is output at the mobile communication device such that a user may specify at least one of the text strings that are obtained.

12. A method comprising:
making a plurality of themes accessible at a site over a network, each to be applied to a user interface of a mobile communication device, one or more of the themes being targetable to a particular demographic through customizable text strings; and
collecting revenue that is based at least in part on access to at least one of the themes.

13. A method as described in claim 12, wherein the customizable text string are to be output in the user interface of the mobile communication device in response to an occurrence of an event at the mobile communication device.

14. A method as described in claim 13, wherein the event includes an incoming telephone call, receipt of a text message, or receipt of an email.

15. A method as described in claim 12, wherein the revenue is collected to output one or more advertisements at the site.

16. A method as described in claim 12, wherein the revenue is collected through purchase of the at least one theme.

17. One or more computer-readable media comprising instructions that are executable by a device to output an option to customize text strings that are to be output in a user interface by the device in response to an occurrence of a respective one of a plurality of events that relate to receipt of a communication at the device.

18. One or more computer-readable media as described in claim 17, wherein another one of the plurality of events relate to hardware functionality of the device.

19. One or more computer-readable media as described in claim 17, wherein the text strings are part of a theme to be applied to the user interface of the device.

20. One or more computer-readable media as described in claim 17, wherein the communication is a telephone call or a text message.
